(19) United States
(12) Patent Application Publication
(10) Pub. No.: US 2026/0019364 A1
(43) Pub. Date: Jan. 15, 2026

(54) TRAFFIC FORWARDING METHOD

(71) Applicant: CLOUD INTELLIGENCE ASSETS HOLDING (SINGAPORE) PRIVATE LIMITED, Singapore (SG)

(72) Inventors: Yang SONG, Hangzhou, Zhejiang (CN); Xiaomin WU, Hangzhou, Zhejiang (CN); Zhigang ZONG, Hangzhou, Zhejiang (CN); Bengbeng XUE, Hangzhou, Zhejiang (CN); Xiaoxin PENG, Hangzhou, Zhejiang (CN); Daxiang KANG, Hangzhou, Zhejiang (CN)

(21) Appl. No.: 18/869,218

(22) PCT Filed: Jun. 28, 2023
(86) PCT No.: PCT/CN2023/103107

§ 371 Date: Nov. 25, 2024

(30) Foreign Application Priority Data
Jun. 29, 2022 (CN) 202210784907.6

(51) Int. Cl. H04L 45/76

(52) U.S. Cl. CPC H04L 45/76

(57) ABSTRACT

Provided in the present disclosure is a traffic forwarding method. The method includes: receiving forward traffic from a source device in a source network, where the forward traffic is targeted at a destination device in a destination network for transmission; distributing the forward traffic to a target network device in an intermediate network for processing; and transmitting, to the destination device, processed forward traffic carrying device identification information of the target network device, to enable reverse traffic returned by the destination device to the source device to carry the device identification information of the target network device, where the device identification information is used for instructing a virtual switch to forward the reverse traffic to the target network device for processing, where the virtual switch corresponds to a routing access point receiving the reverse traffic in the intermediate network.

### CROSS-REFERENCE TO RELATED APPLICATIONS

This application is a National Stage of International Application No. PCT/CN2023/103107, filed on Jun. 28, 2023, which claims priority to Chinese Patent Application No. 202210784907.6, filed with China National Intellectual Property Administration on Jun. 29, 2022 and entitled “TRAFFIC FORWARDING METHOD”. The two applications are incorporated herein by reference in their entireties.

### TECHNICAL FIELD

The present specification relates to the field of data transmission technologies and, in particular, to a traffic forwarding method.

### BACKGROUND

With the development of cloud technologies, a growing number of users migrate local network functions to the cloud, among others, a third-party network device deployed by the user under the cloud is also migrated to the cloud. However, a problem frequently encountered during the migration is that the forward traffic and the reverse traffic are non-accessible to a same network device, which hinders the user from a cloud process.

In the related art, a technology similar to a gateway load balancer (GWLB) is generally adopted to ensure that the forward traffic and the reverse traffic passing through a same availability zone are accessible to a same network device, however, the consistency of network devices accessing the forward traffic and the reverse traffic cannot be ensured in a scenario where there are a plurality of availability zones or the availability zones are changed, thereby limiting usage scenarios of user-related complex network devices.

### SUMMARY

In view of this, the present specification provides a traffic forwarding method to address deficiencies in the related art.

Specifically, the present specification is implemented through the following technical solutions.

According to a first aspect of the embodiments of the present specification, provided is a traffic forwarding method, applied to a virtual switch corresponding to any routing access point in an intermediate network, where the intermediate network is deployed across a plurality of availability zones, and the intermediate network is provided with at least two network devices respectively located in different availability zones as well as routing access points located in the same availability zones as the at least two network devices, the method includes:
receiving forward traffic from a source device in a source network, where the forward traffic is targeted at a destination device in a destination network for transmission;
distributing the forward traffic to a target network device in the intermediate network for processing; and
transmitting, to the destination device, processed forward traffic carrying device identification information of the target network device, to enable reverse traffic returned by the destination device to the source device to carry the device identification information of the target network device, where the device identification information is used for instructing a virtual switch to forward the reverse traffic to the target network device for processing, where the virtual switch corresponds to a routing access point receiving the reverse traffic in the intermediate network.

According to a second aspect of the embodiments of the present specification, provided is a traffic forwarding method, applied to a virtual switch corresponding to a destination device in a destination network, the method includes:
receiving processed forward traffic forwarded by an intermediate network, where the processed forward traffic carries device identification information of a target network device, and the device identification information is used to characterize that, after a virtual switch corresponding to any routing access point in the intermediate network receives forward traffic transmitted by a source device, the forward traffic is distributed to the target network device in the intermediate network for processing; where the intermediate network is deployed across a plurality of availability zones, and the intermediate network is provided with at least two network devices respectively located in different availability zones as well as routing access points located in the same availability zones as the at least two network devices;
storing the device identification information of the target network device; and
under a circumstance that the destination device needs to return reverse traffic to the source device, adding the stored device identification information to the reverse traffic and then transmitting the same, to instruct the virtual switch, which corresponds to a routing access point receiving the reverse traffic in the intermediate network, to forward the reverse traffic to the target network device for processing.

According to a third aspect of the embodiments of the present specification, provided is a computer-readable storage medium on which a computer program is stored, where steps of the method described in the first aspect are implemented when the program is executed by a processor.

According to a fourth aspect of the embodiments of the present specification, provided is an electronic device, including: a memory, a processor, and a computer program stored in the memory and capable of running on the processor, where steps of the method described in the first aspect are implemented when the program is executed by the processor.

In the technical solutions provided in the present specification, with the technical means of adding device identification information to forward traffic, a routing access point of an intermediate network can forward, based on the device identification information carried in reverse traffic, the reverse traffic to a network device corresponding to the forward traffic for processing, thereby ensuring the consistency of network devices accessing the forward traffic and the reverse traffic while avoiding impacts caused by multiple availability zones.

It should be understood that the foregoing general description and the detailed description hereinafter are only exemplary and explanatory, and cannot limit the present specification.

### BRIEF DESCRIPTION OF DRAWING

In order to describe the technical solutions in the embodiments of the present specification or the existing technology more clearly, the accompanying drawings used in the description of the embodiments or the existing technology will be briefly described hereunder. Apparently, the drawings in the following description are intended for just some embodiments recorded in the present specification. For persons of ordinary skill in the art, other drawings may be obtained based on these drawings.

FIG. 1 is a schematic architecture diagram of a traffic forwarding system according to an exemplary embodiment of the present specification.

FIG. 2 is a schematic flow diagram of a traffic forwarding method according to an exemplary embodiment of the present specification.

FIG. 3 is a schematic flow diagram of another traffic forwarding method according to an exemplary embodiment of the present specification.

FIG. 4a is a schematic flow diagram of a forward traffic forwarding method according to an exemplary embodiment of the present specification.

FIG. 4b is a schematic flow diagram of a reverse traffic forwarding method according to an exemplary embodiment of the present specification.

FIG. 5a is a schematic flow diagram of another forward traffic forwarding method according to an exemplary embodiment of the present specification.

FIG. 5b is a schematic flow diagram of another reverse traffic forwarding method according to an exemplary embodiment of the present specification.

FIG. 6 is a schematic structure diagram of an electronic device according to an exemplary embodiment of the present specification.

FIG. 7 is a schematic structure diagram of a traffic forwarding apparatus according to an exemplary embodiment of the present specification.

FIG. 8 is a schematic structure diagram of another traffic forwarding apparatus according to an exemplary embodiment of the present specification.

### DESCRIPTION OF EMBODIMENTS

Exemplary embodiments will be described in detail herein, examples of which are illustrated in the accompanying drawings. When the following description relates to the accompanying drawings, the same number in different drawings represents the same or similar elements unless indicated otherwise. Implementations described in the following exemplary embodiments do not represent all implementations that are consistent with the present specification. Instead, they are merely examples of apparatuses and methods that are consistent with some aspects of the present specification as detailed in the appended claims.

The terms used in the present specification are merely for the purpose of describing specific embodiments, but are not intended to limit the present specification. Singular forms such as “a”, “the” and “this” used in the present specification and the appended claims are also intended to include plural forms unless other meanings are explicitly indicated in the context. It will also be appreciated that the term “and/or” as used herein refers to and includes any of or all of possible combinations of one or more associated items listed.

It will be appreciated that although the terms such as “first”, “second”, “third” and the like may be used in the present specification to describe various information, such information should not be limited to these terms. These terms are only used to distinguish information of the same type. For example, without departing from the scope of the present specification, first information may also be referred to as second information; similarly, second information may also be referred to as first information. Depending on the context, the word “if” as used herein can be interpreted as “once . . . ” or “when . . . ” or “in response to determining that”

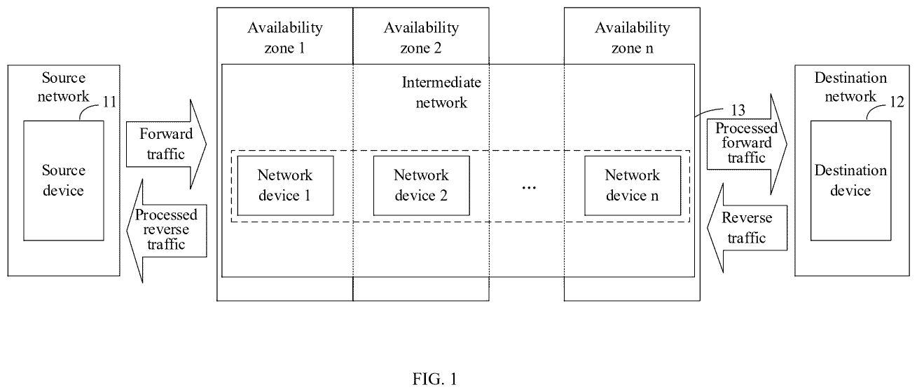

FIG. 1 is a schematic architecture diagram of a traffic forwarding system according to an exemplary embodiment of the present specification. A source device 11, a destination device 12, and a network device group 13 may be included.

The source device 11 and the destination device 12 refer to electronic devices supporting network traffic transmitting and receiving functions, and are respectively connected to a source network and a destination network. The source network and the destination network are independent of each other, and traffic thereto and therefrom needs to be processed by a same network device in a network device group 13 of an intermediate network. During the operation of the system, when the source device 11 initiates forward traffic to the destination device 12, the forward traffic is transmitted to the destination device 12 in the destination network after being processed by any network device in the intermediate network; when the destination device 12 needs to return reverse traffic to the source device 11 subsequently, the reverse traffic is transmitted to the source device 11 in the source network after being processed again by the network device in the intermediate network (that is, the network device through which the forward traffic flows). A user may use, for example, the following types of electronic devices as the source device 11 and the destination device 12: cloud servers, bare metal servers, mobile phones, tablet devices, notebook computers, personal digital assistants (PDAs) and wearable devices (such as smart glasses, smart watches, or the like) that are formed based on a virtualization technology. The aforementioned cloud servers and bare metal servers formed based on the virtualization technology may be deployed across a data center, which is not limited in one or more embodiments of the present specification.

The network device group 13 includes one or more network devices, which are electronic devices providing network functions in the middle section of a network link. The one or more network devices have the same configuration, and are separately disposed in different availability zones of the intermediate network. The network device includes, but is not limited to, a firewall, a traffic analysis component, and a load balancing component. The source network, the destination network and the intermediate network may be respectively established by a physical server of an independent host or established for a virtual server borne by a host cluster, which is not limited in the present specification.

It should be noted that “source” and “destination” are a group of relative concepts, and are not used to particularly refer to specific electronic devices. For example, when the description is made based on the perspective of the device 11, the device 11 may be used as a source device, and the device 12 may be used as a destination terminal; when the description is made based on the perspective of the device 12, the device 12 may be used as a source device, and the device 11 may be used as a destination device. In FIG. 1, an example is taken through description from the perspective of the device 11, and hence the description is made by means of the source device 11 and the destination device 12 described above.

Similarly, “forward” and “reverse” are also a group of relative concepts. The forward traffic and the reverse traffic may be in a request-response relationship, or may not have a functional necessity. For example, the forward traffic may be a response to previous reverse traffic, and the reverse traffic may be a request in a new round. In the present specification, “forward” and “reverse” are only used to represent a chronological order for traffic transmission. When the device 11 firstly transmits traffic to the device 12, the traffic is forward traffic, and the traffic that the device 12 subsequently returns to the device 11 is reverse traffic; when the device 12 firstly transmits traffic to the device 11, the traffic is forward traffic, and the traffic that the device 11 subsequently returns to the device 12 is reverse traffic. In FIG. 1, description is given by taking an example from the perspective of the device 11 firstly transmitting the traffic to the device 12, and hence the description is made in a manner of the device 11 transmitting forward traffic to the device 12 and the device 12 transmitting reverse traffic to the device 11.

The traffic forwarding method in the present specification can be applied to a virtual switch corresponding to any routing access point in an intermediate network. The intermediate network is deployed across a plurality of availability zones, and the intermediate network is provided with at least two network devices respectively located in different availability zones as well as routing access points located in the same availability zones as the at least two network devices.

The aforementioned routing access points are used as virtual interfaces of respective availability zones in the intermediate network; each routing access point corresponds to a virtual switch; and the virtual switch of the routing access point can be used for receiving traffic from a corresponding availability zone, forwarding the traffic to a network device in a corresponding availability zone, and then transmitting, to another network, the traffic which is processed and then returned by the network device. The correspondence between the virtual switch and the routing access point may be designed according to actual requirements. For example, a routing access point and a virtual switch in a same availability zone may have a “one-to-one”, “one-to-many”, “many-to-one”, or “many-to-many” relationship, which is not limited in the present specification.

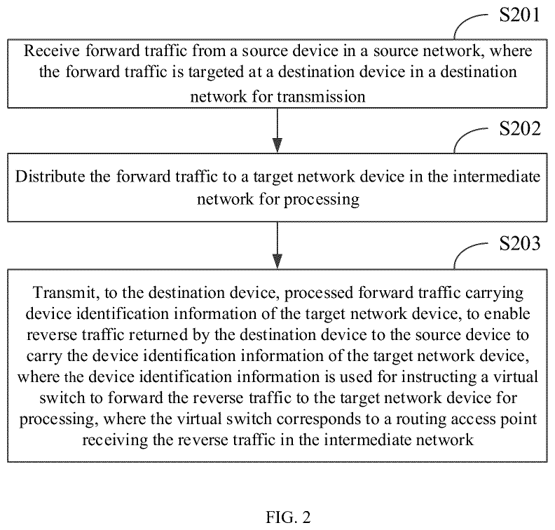

FIG. 2 is a schematic flow diagram of a traffic forwarding method according to an exemplary embodiment of the present specification. As shown in FIG. 2, the method is applied to a virtual switch corresponding to any routing access point in an intermediate network; the intermediate network is deployed across a plurality of availability zones; and the intermediate network is provided with at least two network devices respectively located in different availability zones as well as routing access points located in the same availability zones as the at least two network devices. The method may include the following steps.

S201: receive forward traffic from a source device in a source network, where the forward traffic is targeted at a destination device in a destination network for transmission.

For example, as mentioned previously, the source network and the destination network are independent of each other, and when the source device in the source network needs to transmit traffic to the destination device in the destination network, the traffic will be received as forward traffic by the virtual switch corresponding to any routing access point in the intermediate network, for further processing by the network device hereinafter.

S202: distribute the forward traffic to a target network device in the intermediate network for processing.

Since the intermediate network is deployed across the plurality of availability zones, and each availability zone can be deployed with one or more network devices, the virtual switch corresponding to any routing access point, after receiving the forward traffic, may select one of the network devices in the plurality of availability zones as the target network device, to process the forward traffic.

Based on information carried in the forward traffic per se, the virtual switch corresponding to any routing access point can determine a manner of selecting the target network device.

In an embodiment, when the forward traffic does not carry device identification information, the virtual switch corresponding to any routing access point can determine the target network device based on a preconfigured traffic distribution policy and forward the forward traffic to the target network device for processing. The device identification information can be used as unique identification of the network device. Meanwhile, the preconfigured traffic distribution policy includes but is not limited to: a preset routing table or a dynamic distribution algorithm.

The preset routing table may be provided with a correspondence between destination addresses and forwarding addresses, and the forwarding addresses may correspond to network addresses of network devices; when address information about a destination device in the forward traffic matches a destination address of any correspondence in the preset routing table, the forward traffic may be forwarded to the network device corresponding to the destination address. However, as a kind of static data, the preset routing table needs voluntary modification, addition or reduction from a system administrator based on changes of the network devices, which results in a failure to timely change the preset routing table based on actual requirements in a complex and volatile network environment (for example, multiple scaling operations are performed for the availability zones, resulting in frequent changes in network locations of related network devices), thereby further affecting the traffic forwarding efficiency.

The aforementioned dynamic distribution algorithm can be regarded as a solution to defects of the aforementioned preset routing table, that is, the aforementioned dynamic distribution algorithm can be used to dynamically distribute traffic based on the running status of the at least two network devices. Those skilled in the art can understand that the aforementioned running status may involve multiple dimensions such as current bandwidth, memory, and CPU and GPU usage rates of the network device, and no limitation is made in the present specification. In addition, the traffic distribution mode of the dynamic distribution algorithm is correlated with the management purpose thereof for network devices, for example, under a circumstance that the management purpose is load balancing, the dynamic distribution algorithm can give an indication to the virtual switch corresponding to any routing access point to evenly distribute the forward traffic to each network device; for another example, under a circumstance that the management purpose is cost reduction of the network devices, the dynamic distribution algorithm can give an indication to the virtual switch corresponding to any routing access point to quantitatively distribute the forward traffic to each network device based on a resource utilization rate of each network device, to ensure that the resource utilization rate of each network device is kept below a preset threshold. In short, the specific embodiment of the dynamic distribution algorithm will vary with the management purpose of the network devices, and no limitation is made in the present specification.

In another embodiment, when the forward traffic carries the device identification information of the target network device, the virtual switch corresponding to any routing access point can determine the target network device based on the device identification information and forward the forward traffic to the target network device for processing. When the target network device is unavailable due to crashes or abnormalities in the target network device even though the forward traffic contains the device identification information of the target network device, the forward traffic may be forwarded to a reassigned target network device for processing. The reassigning process may be carried out based on the previous embodiment.

For example, as mentioned previously, the forward traffic and the reverse traffic described above are taken as a group of relative concepts, which may not have a functional necessity. Therefore, when the target network device is unavailable even though the reverse traffic passing through the virtual switch corresponding to any routing access point in the intermediate network contains the device identification information of the target network device, the reverse traffic can also be forwarded to a reassigned target network device for processing.

S203: transmit, to the destination device, processed forward traffic carrying device identification information of the target network device, to enable reverse traffic returned by the destination device to the source device to carry the device identification information of the target network device, where the device identification information is used for instructing a virtual switch to forward the reverse traffic to the target network device for processing, where the virtual switch corresponds to a routing access point receiving the reverse traffic in the intermediate network.

After the target network device has processed the forward traffic, the device

identification information of the target network device may be added to the forward traffic, so that the reverse traffic returned by the destination device to the source device after the forward traffic is received also carries the device identification information of the target network device. The device identification information plays the same role in the reverse traffic as in the forward traffic, that is, it is used to forward the reverse traffic to the target network device in the intermediate network.

The process of adding the device identification information to the forward traffic can be arranged in different operation steps based on actual requirements.

In an embodiment, the virtual switch corresponding to the target network device may add the device identification information of the target network device to the processed forward traffic. In fact, an operation to add the device identification information can be performed at the first time when the device identification information of the target network device is acquired, and thus under a similar circumstance that the device identification information is stored in advance in the virtual switch corresponding to the target network device, the device identification information can be directly added before the forward traffic is processed, and no limitation is made in the present specification.

In another embodiment, after receiving the processed forward traffic returned which is processed and then returned by the target network device, the virtual switch corresponding to the routing access point may add the device identification information of the target network device to the processed forward traffic. Similar to the previous embodiment, under a similar circumstance that the device identification information is stored in advance in the virtual switch corresponding to the routing access point, the device identification information may be added to the forward traffic before the forward traffic is transmitted to the virtual switch corresponding to the target network device, and no limitation is made in the present specification.

The source network and the destination network are similar to the intermediate network, and can also be deployed across a plurality of availability zones. For the source network, the source device and the routing access point in the source network may be deployed across a same availability zone in the source network, or they may be respectively deployed across different availability zones in the source network. The routing access point can be used for the source device to effectuate a cross-network interaction. For example, if the source network has two availability zones 1 and 2 therein, and is provided with a source device and a routing access point separately, then the source device in the availability zone 1 can initiate forward traffic with the destination device in the destination network through the routing access point in the availability zone 2, or the source device in the availability zone 1 can receive, through the routing access point in the availability zone 2, reverse traffic returned by the destination device in the destination network. For the destination network, the destination device and the routing access point in the destination network can be deployed across a same availability zone in the destination network, or they can be deployed across different availability zones in the destination network. The routing access point can be used for the destination device to effectuate a cross-network interaction. For example, if the destination network has two availability zones 1 and 2 therein, and is provided with a destination device and a routing access point separately, then the destination device in the availability zone 1 can receive, through the routing access point in the availability zone 2, forward traffic returned by the destination device in the destination network, or the destination device in the availability zone 1 can transmit, through the routing access point in the availability zone 2, reverse traffic to the destination device in the destination network.

The device identification information can be used to characterize network device uniqueness, such as elastic network interface (ENI) address information, so that the virtual switch which corresponds to a routing access point receiving the forward traffic and/or the reverse traffic in the intermediate network forwards the forward traffic and/or the reverse traffic to the unique network device.

Different addition operations can be performed on the elastic network interface ENI address information based on a format in which the device identification information is encapsulated into the forward traffic and/or the reverse traffic.

In an embodiment, the forward traffic and/or the reverse traffic may use in a virtual extensible local area network VXLAN encapsulation mode, and the device identification information is stored in an inner source MAC address field of a packet corresponding to the forward traffic and/or the reverse traffic.

In another embodiment, the forward traffic and/or the reverse traffic may use a network virtualization protocol GENEVE encapsulation mode, and the device identification information is stored in an option field of a packet corresponding to the forward traffic and/or the reverse traffic.

Those skilled in the art can understand that a specific encapsulation format used for the forward traffic and/or the reverse traffic is not limited in the present description, and the present description only requires that the aforementioned device identification information can be reasonably added to the forward traffic and/or the reverse traffic based on a traffic format.

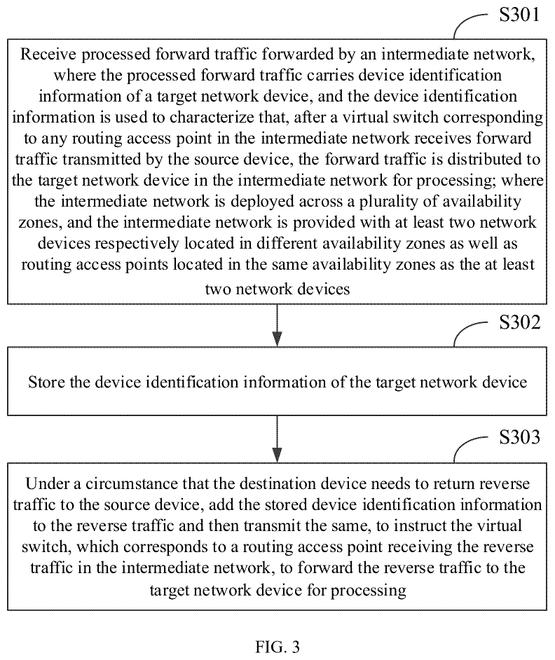

FIG. 3 is a schematic flow diagram of another traffic forwarding method according to an exemplary embodiment of the present specification. As shown in FIG. 3, the method is applied to a virtual switch corresponding to a destination device in a destination network, and may include the following steps.

S301: receive processed forward traffic forwarded by an intermediate network, where the processed forward traffic carries device identification information of a target network device, and the device identification information is used to characterize that, after a virtual switch corresponding to any routing access point in the intermediate network receives forward traffic transmitted by a source device, the forward traffic is distributed to the target network device in the intermediate network for processing; where the intermediate network is deployed across a plurality of availability zones, and the intermediate network is provided with at least two network devices respectively located in different availability zones as well as routing access points located in the same availability zones as the at least two network devices.

After the target network device in the intermediate network processes the forward traffic, the virtual switch corresponding to the destination device in the destination network can receive the processed forward traffic. The processed forward traffic contains the device identification information of the target network device, acting as a premise to perform an addition operation of the device identification information for the reverse traffic hereinafter.

S302: store the device identification information of the target network device.

The virtual switch corresponding to the destination device in the destination network can store the device identification information of the target network device into a storage space connected to the virtual switch, or instruct the destination device to store the device identification information of the target network device into a storage space connected to the destination device, which is not limited in the present specification.

S303: under a circumstance that the destination device needs to return reverse traffic to the source device, add the stored device identification information to the reverse traffic and then transmit the same, to instruct the virtual switch, which corresponds to a routing access point receiving the reverse traffic in the intermediate network, to forward the reverse traffic to the target network device for processing. When the reverse traffic carries the same device identification information

as the forward traffic, the reverse traffic, when passing through the intermediate network, can also be processed via the network device corresponding to the device identification information, thereby achieving consistency between the forward traffic and the reverse traffic. Meanwhile, a condition for the destination device to add the device identification information is not limited in the present specification. For example, the virtual switch corresponding to the destination device would add the stored device identification information to reverse traffic only when the destination device transmits the reverse traffic to a source device that has previously transmitted forward traffic to it. For another example, when the destination device transmits reverse traffic to any other network device including the source device, the virtual switch corresponding to the destination device adds the stored device identification information to the reverse traffic.

For example, as mentioned previously, since network devices are at a risk of crashing or being abnormal, even if the destination device receives the forward traffic twice from the source device, there might be a situation that the forward traffic at two times may carry different device identification information. Therefore, the virtual switch corresponding to the destination device can update the stored device identification information under a circumstance that the device identification information carried in the processed forward traffic is inconsistent with pre-stored device identification information, thereby ensuring the validity of the device identification information.

Through the foregoing embodiments, it can be seen that the present specification, by virtue of the technical means of adding the device identification information to the forward traffic, enables the routing access point of the intermediate network to forward, based on the device identification information carried in the reverse traffic, the reverse traffic to the network device corresponding to the forward traffic for processing, thereby ensuring the consistency of network devices accessing the forward traffic and the reverse traffic and avoiding impacts due to scaling of multiple availability zones. Meanwhile, the design of the destination device and the source device in the destination network and the source network as well as corresponding routing access points avoids a limitation in the related art that the source device and the destination device are required to have the routing access points located in a same availability zone.

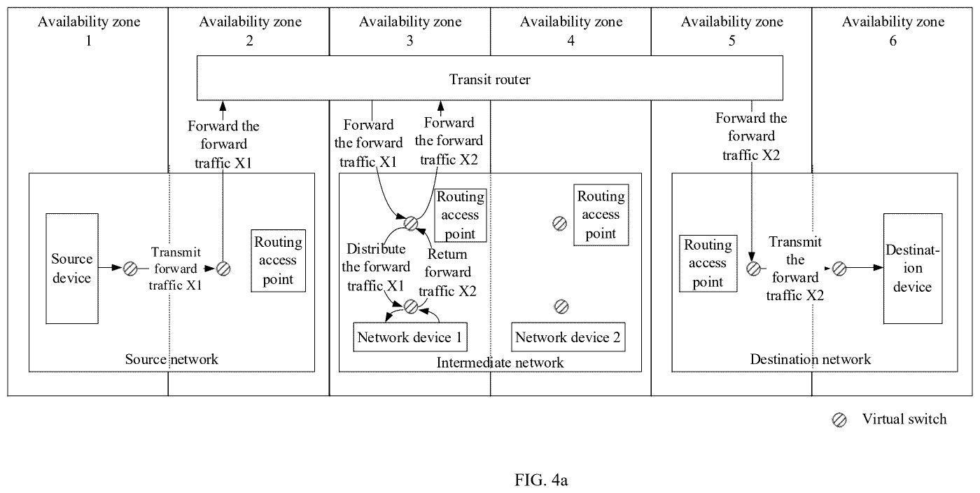

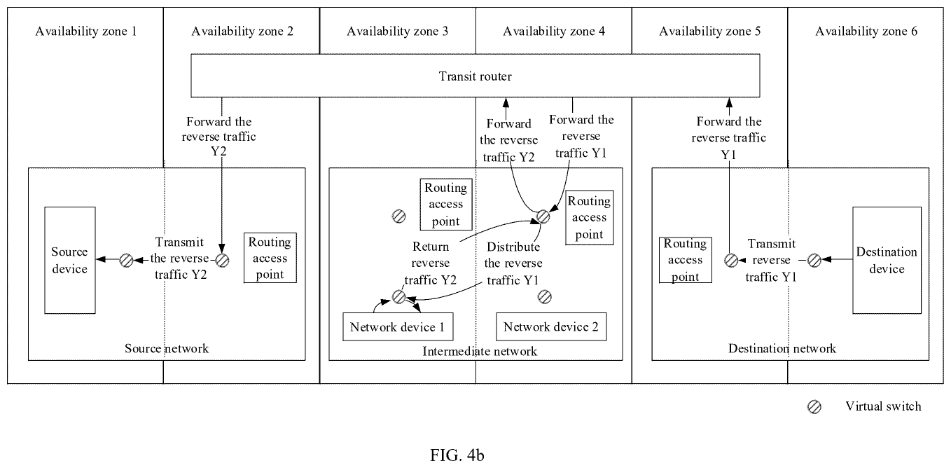

The technical solutions of the present specification will be described hereunder with reference to the embodiment shown in FIG. 4a. FIG. 4a is a schematic flow diagram of a forward traffic forwarding method according to an exemplary embodiment of the present specification. As shown in FIG. 4a, there are a source network, a destination network, and an intermediate network. As shown in FIG. 4a, the respective networks are located in availability zones 1-6 of a same area, and traffic transmission is implemented among the respective networks through a transit router (TR). In addition, the source network or the destination network respectively has a routing access point located in a different availability zone from the source device or the destination device. Meanwhile, the intermediate network has therein two routing access points, which together with two network devices are disposed in availability zones 3 and 4 as shown in the figure. The method can be divided into the following steps.

The source device in the availability zone 1 needs to transmit forward traffic X1 to the destination device, where the forward traffic X1 firstly arrives at a virtual router corresponding to the source device, and the forward traffic X1 adopts a GENEVE format.

A virtual router corresponding to the source device confirms that there is no pre-stored device identification information and thus an operation for adding device identification information is ignored, and by querying a preset routing table, determines that a forwarding address for transmission of the forward traffic X1 is a virtual router corresponding to the routing access point in the availability zone 2.

The virtual router corresponding to the routing access point in the availability zone 2 transmits the forward traffic X1 to a transit router, and the transit router forwards the forward traffic X1 to a virtual router corresponding to the routing access point in the availability zone 3 based on a pre-set traffic forwarding policy, where the pre-set traffic forwarding policy is used to maintain a traffic forwarding relationship among the respective routing access points.

The virtual router corresponding to the routing access point in the availability zone 3 determines that the forward traffic X1 does not carry therein device identification information, and thus determines the network device 1 in the intermediate network as a target network device based on the pre-set traffic distribution policy, and transmits the forward traffic X1 to a virtual router corresponding to the target network device.

After receiving the forward traffic X1, the virtual router corresponding to the network device in the availability zone 3 forwards the forward traffic X1 to the network device in the availability zone 3 for processing to obtain forward traffic X2, and transmits the forward traffic X2 and ENI address information of the target network device to the virtual router corresponding to the routing access point in the availability zone 3.

The virtual router corresponding to the routing access point in the availability zone 3 adds the ENI address information to the received forward traffic X2. Since the forward traffic X2 adopts the GENEVE format, the ENI address information of the target network device is stored in an option field of a packet corresponding to the forward traffic X2.

The virtual router corresponding to the routing access point in the availability zone 3 transmits the forward traffic X2 to the transit router, and the transit router forwards the forward traffic X2 to a virtual router corresponding to a routing access point in the availability zone 5 based on the preset traffic forwarding policy.

The virtual router corresponding to the routing access point in the availability zone 5 transmits the forward traffic X2 to a virtual switch of the destination device. In this case, since the forward traffic X2 carries the ENI address information of the target network device, the virtual switch of the destination device can locally store the ENI address information of the target network device.

The technical solutions of the present specification will be further described hereunder with reference to the embodiment shown in FIG. 4b, where the network structure of FIG. 4b is basically the same as that of FIG. 4a, and details will not be described herein again. FIG. 4b is a schematic flow diagram of a reverse traffic forwarding method according to an exemplary embodiment of the present specification. As shown in FIG. 4b, the method may be divided into the following steps.

The destination device in the availability zone 6 needs to transmit reverse traffic Y1 to the source device, where the reverse traffic Y1 firstly arrives at a virtual router corresponding to the destination device, and the reverse traffic Y1 adopts a GENEVE format.

The virtual router corresponding to the destination device writes the ENI address information of the target network device into an option field of a packet corresponding to the reverse traffic Y1 based on the pre-stored device identification information (that is, the ENI address information of the target network device) and the format of the reverse traffic Y1, and by querying a preset routing table, determines that a forwarding address for transmission of the reverse traffic Y1 is a virtual router corresponding to the routing access point in the availability zone 5.

The virtual router corresponding to the routing access point in the availability zone 5 transmits the reverse traffic Y1 to the transit router. In the present embodiment, it is assumed that the reverse traffic Y1 is forwarded to a virtual router corresponding to the routing access point in the availability zone 4. Since the reverse traffic Y1 might be forwarded to different availability zones corresponding to the intermediate network (that is, the availability zone 3 or the availability zone 4), and forwarded to virtual routers in different availability zones, and different manners might be used on different virtual routers to select network devices, a problem occurring in the related art is that forward traffic and reverse traffic might be forwarded to different network devices for processing. However, in the present embodiment, the transit router can forward the reverse traffic Y1 to any virtual router corresponding to the routing access point in the availability zone 3 or the availability zone 4 based on a preset traffic forwarding policy, and ensure that the forward traffic and the reverse traffic pass through the same network device.

The virtual router corresponding to the routing access point in the availability zone 4 determines that the reverse traffic Y1 carries therein device identification information, and thus determines the network device (that is, the network device in the availability zone 3) corresponding to the device identification information as a target network device based on the preset traffic distribution policy, and transmits the reverse traffic Y1 to a virtual router corresponding to the target network device.

After receiving the reverse traffic Y1, the virtual router corresponding to the network device in the availability zone 3 forwards the reverse traffic Y1 to the network device in the availability zone 3 for processing to obtain reverse traffic Y2, and transmits the reverse traffic Y2 and ENI address information of the target network device to the virtual router corresponding to the routing access point in the availability zone 4.

The virtual router corresponding to the routing access point in the availability zone 4 adds the ENI address information to the received reverse traffic Y2 again. Similar to the forward traffic, since the reverse traffic Y2 adopts the GENEVE format, the ENI address information of the target network device remains on an option field of a packet corresponding to the reverse traffic Y2.

The virtual router corresponding to the routing access point in the availability zone 4 transmits the reverse traffic Y2 to the transit router, and the transit router forwards the reverse traffic Y2 to the virtual router corresponding to the routing access point in the availability zone 2 based on the preset traffic forwarding policy.

The virtual router corresponding to the routing access point in the availability zone 2 transmits the reverse traffic Y2 to the virtual switch of the source device. In this case, since the reverse traffic Y2 carries the ENI address information of the target network device, the virtual switch of the source device can also locally store the ENI address information of the target network device. If a same flow of traffic is transmitted via the source device, it will also carry the ENI address information of the target network device, thereby ensuring that the forward traffic and the reverse traffic are still accessible to a same network device when network devices in the intermediate network are scaled in terms of capacity.

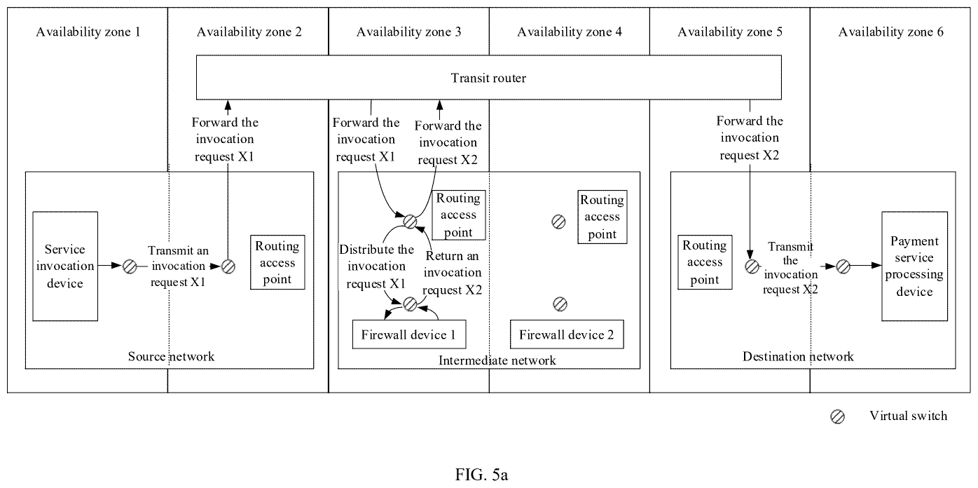

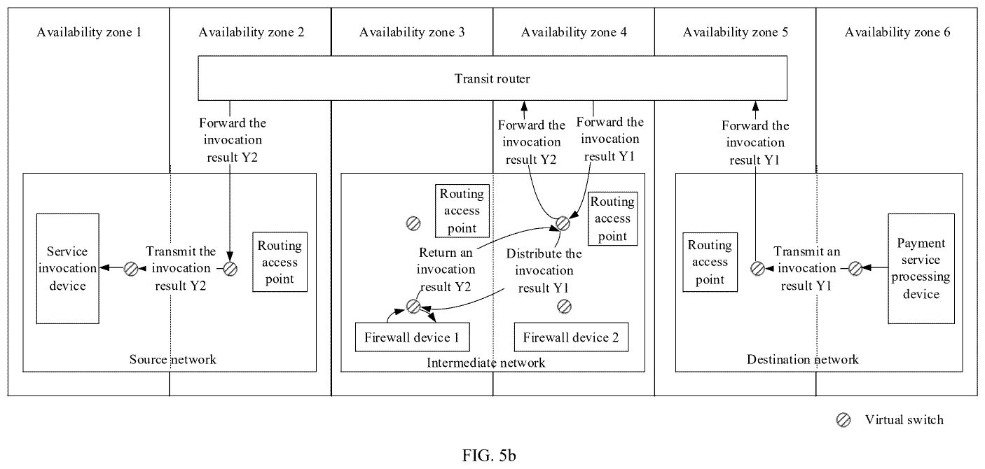

The technical solutions of the present specification will be described hereunder with reference to the embodiment shown in FIG. 5a. FIG. 5a is a schematic flow diagram of another forward traffic forwarding method according to an exemplary embodiment of the present specification. As shown in FIG. 5a, there are a source network, a destination network, and an intermediate network. As shown in FIG. 5a, the respective networks are located in availability zones 1-6 of a same area, and traffic transmission is implemented among the respective networks through a transit router. In addition, the source network or the destination network respectively has a routing access point located in a different availability zone from a service invocation device (that is, a device deployed with security authentication services and load balancing services) or a payment service processing device. Meanwhile, the intermediate network has therein two routing access points, which together with two firewall devices are disposed in the availability zones 3 and 4 as shown in the figure. The method can be divided into the following steps.

It is assumed that a user initiates a payment request to a payment platform by using e-commerce software in a mobile terminal, and the payment request is received by a cloud server corresponding to the e-commerce software, and a corresponding payment service is invoked by a service invocation device in the cloud server. Then, the service invocation device in the availability zone 1 needs to transmit an invocation request X1 to the payment service processing device, where the invocation request X1 first arrives at a virtual router corresponding to the service invocation device, and the invocation request X1 adopts a GENEVE format.

The virtual router corresponding to the service invocation device confirms that there is no pre-stored device identification information and thus an operation for adding device identification information is ignored, and by querying a preset routing table, determines that a forwarding address for transmission of the invocation request X1 is a virtual router corresponding to the routing access point in the availability zone 2.

The virtual router corresponding to the routing access point in the availability zone 2 transmits the invocation request X1 to a transit router, and the transit router forwards the invocation request X1 to a virtual router corresponding to the routing access point in the availability zone 3 based on a preset traffic forwarding policy.

The virtual router corresponding to the routing access point in the availability zone 3 determines that the invocation request X1 does not carry the device identification information, and thus transmits the invocation request X1 to a virtual router corresponding to the firewall device 1 based on the preset traffic distribution policy.

After receiving the invocation request X1, the virtual router corresponding to the firewall device 1 in the availability zone 3 forwards the invocation request X1 to the firewall device 1 in the availability zone 3; meanwhile, the firewall device 1 performs status recording and detection for the invocation request X1, and transmits an output invocation request X2 and ENI address information of the firewall device 1 to the virtual router corresponding to the routing access point in the availability zone 3.

The virtual router corresponding to the routing access point in the availability zone 3 adds the ENI address information to the received invocation request X2. Since the invocation request X2 adopts the GENEVE format, the ENI address information of the firewall device 1 is stored in an option field of a packet corresponding to the invocation request X2.

The virtual router corresponding to the routing access point in the availability zone 3 transmits the invocation request X2 to the transit router, and the transit router forwards the invocation request X2 to a virtual router corresponding to the routing access point in the availability zone 5 based on the preset traffic forwarding policy.

The virtual router corresponding to the routing access point in the availability zone 5 transmits the invocation request X2 to the virtual switch of the payment service processing device. In this case, since the invocation request X2 carries the ENI address information of the firewall device 1, the virtual switch of the payment service processing device can locally store the ENI address information of the firewall device 1.

At the same time, the payment service processing device can execute a corresponding payment service after receiving the invocation request X2.

The technical solutions of the present specification will be further described hereunder with reference to the embodiment shown in FIG. 5b, where the network structure of FIG. 5b is basically the same as that of FIG. 5a, and details will not be described herein again. FIG. 5b is a schematic flow diagram of a reverse traffic forwarding method according to an exemplary embodiment of the present specification. As shown in FIG. 5b, the method can be divided into the following steps.

After successfully receiving and executing the invocation request, the payment service processing device in the availability zone 6 can transmit an invocation result Y1 to the service invocation device, where the invocation result Y1 first arrives at the virtual router corresponding to the payment service processing device, and the invocation result Y1 adopts the GENEVE format.

The virtual router corresponding to the payment service processing device writes the ENI address information of the firewall device 1 into an option field of a packet corresponding to the invocation result Y1 based on the pre-stored device identification information (that is, the ENI address information of the firewall device 1) and the format of the invocation result Y1, and by querying a preset routing table, determines that a forwarding address for transmission of the invocation result Y1 is a virtual router corresponding to the routing access point in the availability zone 5.

The virtual router corresponding to the routing access point in the availability zone 5 transmits the invocation result Y1 to the transit router, and in the present embodiment, it is assumed that the invocation result Y1 is forwarded to a virtual router corresponding to the routing access point in the availability zone 4. Since the invocation result Y1 might be forwarded to different availability zones corresponding to the intermediate network (that is, the availability zone 3 or the availability zone 4), and forwarded to virtual routers in different availability zones, and different manners might be used on different virtual routers to select firewall devices, a problem occurring in the related art is that the invocation result is forwarded to different firewall devices for processing. However, in the present embodiment, the transit router can forward the invocation result Y1 to any virtual router corresponding to the routing access point in the availability zone 3 or the availability zone 4 based on the preset traffic forwarding policy, and ensures that the invocation result passes through the same firewall device.

The virtual router corresponding to the routing access point in the availability zone 4 determines that the invocation result Y1 carries therein device identification information, and thus determines the firewall device 1 corresponding to the device identification information based on the preset traffic distribution policy, and transmits the invocation result Y1 to the virtual router corresponding to the firewall device 1.

After receiving the invocation result Y1, the virtual router corresponding to the firewall device 1 in the availability zone 3 forwards the invocation result Y1 to the firewall device 1 in the availability zone 3. Also, since the firewall device 1 has previously performed the status recording for the invocation request, the invocation result will not trigger a security warning of the firewall device 1, and the firewall device 1 can transmit an output invocation result Y2 and the ENI address information of the firewall device 1 to the virtual router corresponding to the routing access point in the availability zone 4.

The virtual router corresponding to the routing access point in the availability zone 4 re-adds the ENI address information to the received invocation result Y2. Similar to the invocation request, since the invocation result Y2 adopts the GENEVE format, the ENI address information of the firewall device 1 remains on an option field of a packet corresponding to the invocation result Y2.

The virtual router corresponding to the routing access point in the availability zone 4 transmits the invocation result Y2 to the transit router, and the transit router forwards the invocation result Y2 to the virtual router corresponding to the routing access point in the availability zone 2 based on the preset traffic forwarding policy.

The virtual router corresponding to the routing access point in the availability zone 2 transmits the invocation result Y2 to the virtual switch of the service invocation device. The service invocation device transmits relevant information to the e-commerce software in the mobile device to enable a user to learn that the payment request has been successfully executed. In this case, since the invocation result Y2 carries the ENI address information of the firewall device 1, the virtual switch of the service invocation device can also locally store the ENI address information of the firewall device 1.

Those skilled in the art can understand that the aforementioned network devices are not necessarily firewall devices. For example, when the payment platform is a data storage platform and the payment request is a page access request, the aforementioned firewall devices may be replaced with traffic analysis components, and the user's use preference in the e-commerce software can be analyzed according to provisions of a relevant privacy policy and with the user's authorization and permission, thereby pushing personalized service information for the user.

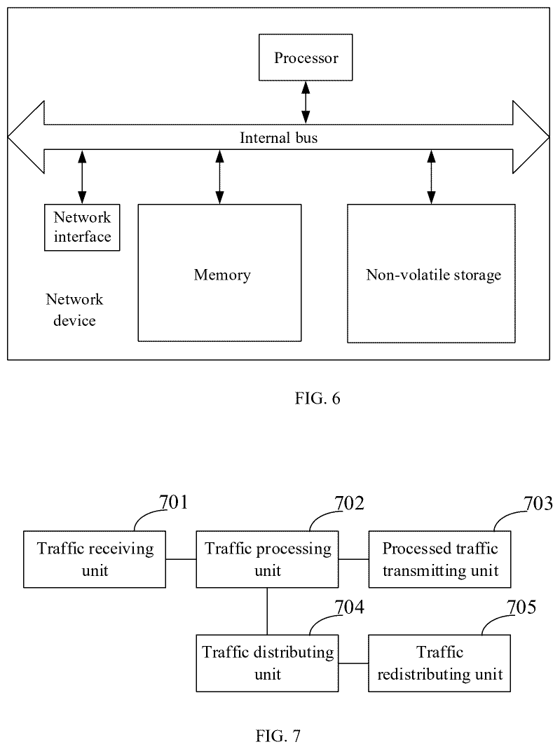

FIG. 6 is a schematic structure diagram of an electronic device according to an exemplary embodiment. Reference may be made to FIG. 6, at a hardware level, the electronic device includes a processor, an internal bus, a network interface, a memory, and a non-volatile storage. Definitely, other desired hardware can also be included. The processor reads a corresponding computer program from the non-volatile storage into the memory and running the computer program, forming a traffic forwarding apparatus at a logical level. Definitely, in addition to software implementations, other implementations are not excluded from the specification, such as a logic device or a combination of software and hardware, etc., that is to say, the execution subject of the following processing flow is not limited to various logic units, but can also be hardware or logic devices.

Corresponding to the embodiments of the traffic forwarding method, the present specification further provides embodiments of a traffic forwarding apparatus.

Reference may be made to FIG. 7, which is a schematic structure diagram of a traffic forwarding apparatus according to an exemplary embodiment. As shown in FIG. 7, in a software implementation, the apparatus is applied to a virtual switch corresponding to any routing access point in an intermediate network, where the intermediate network is deployed across a plurality of availability zones, and the intermediate network is provided with at least two network devices respectively located in different availability zones as well as routing access points located in the same availability zones as the at least two network devices, the apparatus may include:
a traffic receiving unit 701, configured to receive forward traffic from a source device in a source network, where the forward traffic is targeted at a destination device in a destination network for transmission;
a traffic processing unit 702, configured to distribute the forward traffic to a target network device in the intermediate network for processing; and
a processed traffic transmitting unit 703, configured to transmit, to the destination device, processed forward traffic carrying device identification information of the target network device, to enable reverse traffic returned by the destination device to the source device to carry the device identification information of the target network device, where the device identification information is used for instructing a virtual switch to forward the reverse traffic to the target network device for processing, where the virtual switch corresponds to a routing access point receiving the reverse traffic in the intermediate network.

In an implementation, the apparatus further includes a traffic distributing unit 704, configured to:
under a circumstance that the forward traffic does not carry the device identification information, determine the target network device based on a preconfigured traffic distribution policy, and forward the forward traffic to the target network device for processing; and
under a circumstance that the forward traffic carries the device identification information of the target network device, determine the target network device based on the device identification information, and forward the forward traffic to the target network device for processing.

In an implementation, the preconfigured traffic distribution policy includes: a preset routing table or a dynamic distribution algorithm, where the dynamic distribution algorithm is used for dynamic traffic distribution based on an operating state of the at least two network devices.

In an implementation, the traffic distributing unit 704 is specifically configured to:
under a circumstance that the forward traffic contains the device identification information of the target network device, but the target network device is unavailable, forward the forward traffic to a reassigned target network device for processing.

In an implementation, the device identification information of the target network device is added to the processed forward traffic by the virtual switch corresponding to the target network device; or
the apparatus further includes:
a traffic redistributing unit 705, configured to add the device identification information of the target network device to the processed forward traffic upon reception of the processed forward traffic which is processed and then returned by the target network device.

In an implementation, the source device and a routing access point in the source network are respectively deployed across different availability zones in the source network, and the routing access point is used for the source device to effectuate a cross-network interaction; and/or,
the destination device and a routing access point in the destination network are respectively deployed across different availability zones in the destination network, and the routing access point is used for the destination device to effectuate a cross-network interaction.

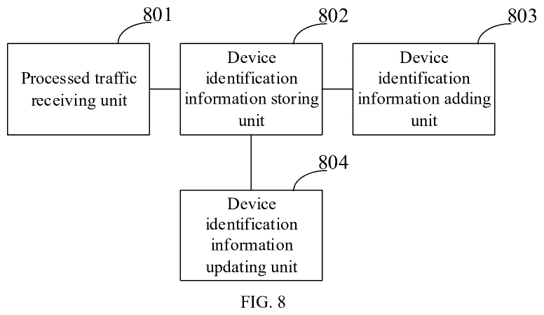

In an implementation, the device identification information is elastic network interface ENI address information corresponding to the target network device. Reference may be made to FIG. 8, which is a schematic structure diagram

of another traffic forwarding apparatus according to an exemplary embodiment. As shown in FIG. 8, in a software implementation, the apparatus is applied to a virtual switch corresponding to a destination device in a destination network, the apparatus may include:
a processed traffic receiving unit 801, configured to receive processed forward traffic forwarded by an intermediate network, where the processed forward traffic carries device identification information of a target network device, and the device identification information is used to characterize that, after a virtual switch corresponding to any routing access point in the intermediate network receives forward traffic transmitted by a source device, the forward traffic is distributed to the target network device in the intermediate network for processing; where the intermediate network is deployed across a plurality of availability zones, and the intermediate network is provided with at least two network devices respectively located in different availability zones as well as routing access points located in the same availability zones as the at least two network devices;
a device identification information storing unit 802, configured to store the device identification information of the target network device; and
a device identification information adding unit 803, configured to: under a circumstance that the destination device needs to return reverse traffic to the source device, add the stored device identification information to the reverse traffic and then transmit the same, to instruct the virtual switch, which corresponds to a routing access point receiving the reverse traffic in the intermediate network, to forward the reverse traffic to the target network device for processing.

The apparatus further includes:
a device identification information updating unit 804, configured to update the stored device identification information when the device identification information carried in the processed forward traffic is inconsistent with pre-stored device identification information.

For the implementation process of the functions and roles of each unit in the above-described apparatuses, reference may be made to the implementation process of the corresponding steps in the above-described method for details, which will not be described here again.

For the apparatus embodiments, since they basically correspond to the method embodiments, reference may be made to description part of the method embodiments for relevant portions. The apparatus embodiments described above are only illustrative. The units described as separate parts may or may not be physically separate, and the components presented as units may or may not be physical units, that is, may be located in one position, or may be distributed on multiple network units. A part or all of the modules may be selected based on actual requirements to achieve the purpose of the solutions of the present specification, and those of ordinary skill in the art can understand and implement them without any creative effort.

Embodiments of subject matters and functional operations described in the present specification can be implemented in the following: digital electronic circuits, tangibly embodied computer software or firmware, computer hardware including the structures disclosed in the present specification and their structural equivalents, or a combination of one or more of them. An embodiment of a subject matter described in the present specification may be implemented as one or more computer programs, that is, one or more modules in computer program instructions encoded on a tangible non-transitory program carrier to be performed by a data processing apparatus or to control an operation of the data processing apparatus. Alternatively or additionally, the program instructions can be encoded on an artificially generated propagation signal, such as a machine-generated electrical, optical, or electromagnetic signal, and the signal is generated to encode and transmit the information to a suitable receiver apparatus for execution by a data processing apparatus. Computer storage media can be machine-readable storage devices, machine-readable storage substrates, random or serial access memory devices, or a combination of one or more of them.

The processing and logic flows described in the present specification may be executed by one or more programmable computers executing one or more computer programs, to perform the corresponding functions by performing manipulations based on input data and generating outputs. The processing and logic flows can also be performed by a dedicated logic circuit, such as a field programmable gate array (FPGA) or an application-specific integrated circuit (ASIC), and the apparatus can also be implemented as a dedicated logic circuit.

Computers suitable for executing computer programs include, for example, general-purpose and/or specialized microprocessors, or any other type of central processing unit. Typically, the central processing unit will receive instructions and data from a read-only memory and/or a random access memory. The basic components of a computer include a central processing unit for implementing or executing instructions and one or more memory devices for storing instructions and data. Typically, the computer will also include one or more mass storage devices for storing data, such as disks, magneto-optical discs, or optical discs, or the computer will be operationally coupled to the mass storage device to receive data from or transmit data to it, or both. However, a computer does not have to have such a device. In addition, a computer can be embedded in another device, such as a mobile phone, personal digital assistant (PDA), mobile audio or video player, game console, global positioning system (GPS) receiver, or portable storage device such as a universal serial bus (USB) flash drive, to name a few.

Computer-readable media suitable for storing computer program instructions and data include all forms of non-volatile memory, media, and memory devices, including, for example, semiconductor memory devices (e.g., EPROMs, EEPROMs, and flash memory devices), disks (e.g., internal hard disks or removable disks), magneto-optical discs, and CD ROMs and DVD-ROM disks. Processors and memories can be supplemented by or incorporated into dedicated logic circuits.

Although the present specification contains many specific embodiments, these embodiments should not be construed as limiting any inventive scope or the claimed scope, but are primarily intended to describe features of specific embodiments of a particular disclosure. Some of the features described in multiple embodiments of the present specification may also be combined in a single embodiment. In another aspect, the various features described in a single embodiment may also be implemented separately or in any suitable combination of sub-embodiments in multiple embodiments. In addition, while features may function in some combinations as described above and even initially claim such protection, one or more features from the combination for which protection is claimed may be removed from that combination in some cases, and the combination for which protection is claimed may point to a sub-combination or a variant of the sub-combination.

Similarly, although operations are depicted in a particular order in the drawings, this should not be construed as requiring those operations to be performed in the particular order or sequentially as shown, or to require all the exemplified operations to be performed to achieve the desired result. In some cases, multitasking and parallel processing can be advantageous. In addition, the separation of the various system modules and components in the foregoing embodiments should not be interpreted as requiring such separation in all embodiments, and it should be understood that the program components and systems described can generally be integrated together in a single software product or packaged into multiple software products.

Therefore, specific embodiments of the subject matters have been described. Other embodiments fall within the scope of the appended claims. In some cases, the actions described in the claims can be performed in a different order and still achieve the desired result. In addition, the processing depicted in the drawings is not necessarily in the specific order or sequence to achieve the desired result. In some implementations, multitasking and parallel processing can be advantageous.

The above descriptions are merely preferred embodiments of the present specification, and are not intended to limit the present specification. Any modification, equivalent replacement, improvement and the like made within the spirit and principle of the present specification shall be included in the scope claimed by the present specification.

1. A traffic forwarding method, applied to a virtual switch corresponding to any routing access point in an intermediate network, wherein the intermediate network is deployed across a plurality of availability zones, and the intermediate network is provided with at least two network devices respectively located in different availability zones as well as routing access points located in the same availability zones as the at least two network devices, the method comprises:
receiving forward traffic from a source device in a source network, wherein the forward traffic is targeted at a destination device in a destination network for transmission;
distributing the forward traffic to a target network device in the intermediate network for processing; and
transmitting, to the destination device, processed forward traffic carrying device identification information of the target network device, to enable reverse traffic returned by the destination device to the source device to carry the device identification information of the target network device,
wherein the device identification information is used for instructing a virtual switch to forward the reverse traffic to the target network device for processing, wherein the virtual switch corresponds to a routing access point receiving the reverse traffic in the intermediate network.

2. The method according to claim 1, wherein the distributing the forward traffic to the target network device for processing comprises:
under a circumstance that the forward traffic does not carry the device identification information, determining the target network device based on a preconfigured traffic distribution policy, and forwarding the forward traffic to the target network device for processing; and
under a circumstance that the forward traffic carries the device identification information of the target network device, determining the target network device based on the device identification information, and forwarding the forward traffic to the target network device for processing.

3. The method according to claim 2, wherein the preconfigured traffic distribution policy comprises: a preset routing table or a dynamic distribution algorithm, wherein the dynamic distribution algorithm is used for dynamic traffic distribution based on an operating state of the at least two network devices.

4. The method according to claim 2, wherein the distributing the forward traffic to the target network device for processing comprises:
under a circumstance that the forward traffic contains the device identification information of the target network device, but the target network device is unavailable, forwarding the forward traffic to a reassigned target network device for processing.

5. The method according to claim 1, wherein:
the device identification information of the target network device is added to the processed forward traffic by the virtual switch corresponding to the target network device; or
the method further comprises: adding the device identification information of the target network device to the processed forward traffic upon reception of the processed forward traffic which is processed and then returned by the target network device.

6. The method according to claim 1, wherein:
the source device and a routing access point in the source network are respectively deployed across different availability zones in the source network, and the routing access point is used for the source device to effectuate a cross-network interaction; and/or,
the destination device and a routing access point in the destination network are respectively deployed across different availability zones in the destination network, and the routing access point is used for the destination device to effectuate a cross-network interaction.

7. The method according to claim 1, wherein the device identification information is elastic network interface ENI address information corresponding to the target network device.

8. A traffic forwarding method, applied to a virtual switch corresponding to a destination device in a destination network, the method comprises:
receiving processed forward traffic forwarded by an intermediate network, wherein the processed forward traffic carries device identification information of a target network device, and the device identification information is used to characterize that, after a virtual switch corresponding to any routing access point in the intermediate network receives forward traffic transmitted by a source device, the forward traffic is distributed to the target network device in the intermediate network for processing; wherein the intermediate network is deployed across a plurality of availability zones, and the intermediate network is provided with at least two network devices respectively located in different availability zones as well as routing access points located in the same availability zones as the at least two network devices;
storing the device identification information of the target network device; and
under a circumstance that the destination device needs to return reverse traffic to the source device, adding the stored device identification information to the reverse traffic and then transmitting the same, to instruct the virtual switch, which corresponds to a routing access point receiving the reverse traffic in the intermediate network, to forward the reverse traffic to the target network device for processing.

9. The method according to claim 8, further comprising:
updating the stored device identification information when the device identification information carried in the processed forward traffic is inconsistent with pre-stored device identification information.

10. A non-transitory computer-readable storage medium on which a computer program is stored, wherein steps of the method according to claim 1 are implemented when the program is executed by a processor.

11. An electronic device, applied to a virtual switch corresponding to any routing access point in an intermediate network, wherein the intermediate network is deployed across a plurality of availability zones, and the intermediate network is provided with at least two network devices respectively located in different availability zones as well as routing access points located in the same availability zones as the at least two network devices, the electronic device comprises: a memory, a processor, and a computer program stored in the memory and capable of running on the processor, wherein the processor, when executing the computer program, is configured to:
receive forward traffic from a source device in a source network, wherein the forward traffic is targeted at a destination device in a destination network for transmission;
distribute the forward traffic to a target network device in the intermediate network for processing; and
transmit, to the destination device, processed forward traffic carrying device identification information of the target network device, to enable reverse traffic returned by the destination device to the source device to carry the device identification information of the target network device,
wherein the device identification information is used for instructing a virtual switch to forward the reverse traffic to the target network device for processing, wherein the virtual switch corresponds to a routing access point receiving the reverse traffic in the intermediate network.

12. The electronic device according to claim 11, wherein the processor is configured to:
under a circumstance that the forward traffic does not carry the device identification information, determine the target network device based on a preconfigured traffic distribution policy, and forward the forward traffic to the target network device for processing; and
under a circumstance that the forward traffic carries the device identification information of the target network device, determine the target network device based on the device identification information, and forward the forward traffic to the target network device for processing.

13. The electronic device according to claim 12, wherein the preconfigured traffic distribution policy comprises: a preset routing table or a dynamic distribution algorithm, wherein the dynamic distribution algorithm is used for dynamic traffic distribution based on an operating state of the at least two network devices.

14. The electronic device according to claim 12, wherein the processor is configured to:
under a circumstance that the forward traffic contains the device identification information of the target network device, but the target network device is unavailable, forward the forward traffic to a reassigned target network device for processing.

15. The electronic device according to claim 11, wherein:
the device identification information of the target network device is added to the processed forward traffic by the virtual switch corresponding to the target network device; or
wherein the processor is configured to: add the device identification information of the target network device to the processed forward traffic upon reception of the processed forward traffic which is processed and then returned by the target network device.

16. The electronic device according to claim 11, wherein:
the source device and a routing access point in the source network are respectively deployed across different availability zones in the source network, and the routing access point is used for the source device to effectuate a cross-network interaction; and/or,
the destination device and a routing access point in the destination network are respectively deployed across different availability zones in the destination network, and the routing access point is used for the destination device to effectuate a cross-network interaction.

17. The electronic device according to claim 11, wherein the device identification information is elastic network interface ENI address information corresponding to the target network device.

18. An electronic device, applied to a virtual switch corresponding to a destination device in a destination network, the electronic device comprises: a memory, a processor, and a computer program stored in the memory and capable of running on the processor, wherein steps of the method according to claim 8 are implemented when the program is executed by the processor.

19. The electronic device according to claim 18, wherein the processor is configured to:
update the stored device identification information when the device identification information carried in the processed forward traffic is inconsistent with pre-stored device identification information.

20. A non-transitory computer-readable storage medium on which a computer program is stored, wherein steps of the method according to claim 8 are implemented when the program is executed by a processor
